(19) United States
(12) Patent Application Publication
(10) Pub. No.: US 2002/0188529 A1
(43) Pub. Date: Dec. 12, 2002

(54) System and method for calculation of controlling parameters for a computer based inventory management

(76) Inventor: Maarten Krever, Leiden (NL)

Correspondence Address: YOUNG & THOMPSON, 745 SOUTH 23RD STREET 2ND FLOOR, ARLINGTON, VA, 22202

(21) Appl. No.: 10/146,958

(22) Filed: May 17, 2002

Related U.S. Application Data
(62) Division of application No. 09/402,589, filed on Oct. 7, 1999.
Application No. 09/402,589 is a 371 of international application No. PCT/NL98/00198, filed on Apr. 7, 1998.

(30) Foreign Application Priority Data
Apr. 7, 1997 (NL) 1005745

(51) Int. Cl. G06F 17/60

(52) U.S. Cl. 705/28

(57) ABSTRACT

A system designed for the calculation of control parameters for a computer based inventory management system according to the present invention comprises a computer program based on mathematical probabilities using statistical distribution functions. In the context of the invention a computer based inventory management system comprises an inventory management program system such as TRITON® as supplied by Baan BV, The Netherlands, running on a computer consisting of at least one processor, memory, input and output.

### TECHNICAL FIELD

This invention relates to inventory management systems and the parameters used therein. In particular the invention deals with the calculation of optimum reorder parameters, optimizing service levels as well as minimizing cost.

Inventory management systems using suitably programmed computers are not unknown as such. As an example may be cited the program system TRITON as supplied by Baan BV, The Netherlands. This program runs on a computer consisting of at least one processor, memory, input and output.

A theoretical exposition of the functionality of such a system can be found in R. H. Ballou, Business Logistics Management, Prentice Hall Inc., 1992 or E. A. Silver and R. Peterson, Decision Systems for Inventory Management and Production Planning, John Wiley & Sons, Inc., 1985

### BACKGROUND TO THE INVENTION

The main aim of inventory management systems is to administrate and maintain a stock of items, such that ideally any order for any item can be filled from stock, while at the same time the stock of items is kept as low as is possible. Constraints such as maximum investment- and minimum service levels must be maintained. Excess of stock should be avoided. In other words, good inventory management involves providing a high product availability or item service level at a reasonable cost.

The service level is defined as the ratio between the number of demands directly served from stock and the total number of demands or, alternatively, as ratio of served quantity and the total quantity demanded.

SL=Served quantity/Total quantity

The service level is a direct consequence of the, in time on the right moment, reordering process for the items in stock. For each item, dependent on the particular supplier of the item, an estimate of the lead time L may be derived.

In order to enable demands to be served from stock during the lead time L, items have to be reordered when a sufficient stock quantity, but no more than that, is still available. This way the demand during the lead time L can be satisfied.

To this end items are reordered when the stock quantity reaches a certain level, the reorder point ROP (see FIG. 1). This reorder point is chosen to enable demands during the lead time to be served, with a certain pre-defined desired service level SLcon.

Another way of managing the stock consists of inspecting the quantity in stock at fixed time intervals (see FIG. 2.). Reordering occurs to a certain predefined, calculated maximum stock level MSL aimed at covering the demand for items during the time intervals between the inspections, with a certain pre-defined desired service level SLcon.

Both methods may be used as well, if the items are not available from a supplier, but are produced in a batch-wise production with a limited production time and production setup time.

Management methods are known, however they differ from the invention in their purpose, their implementation and their mathematical basis.

U.S. Pat. No. 5,287,267, Feb. 15, 1994

This patent describes a method of controlling an inventory of parts, in particular components needed for the fabrication of products, the same part sometimes being used in a plurality of products, where the actual demand for the products is unknown. Based on estimated forecasts and confidence intervals for the different products, and bills of material, which express the quantities of the parts which are needed as components for each of the products, estimates of the total number of parts required are obtained.

The optimum to an objective aimed at minimization of excess stock, is found using a standard iterative procedure where the solution is found by use of a parametric search on the value of a Lagrange multiplier.

This patent describes a method of managing an inventory of fast moving consumables, predicting near future consumption by the use of statistics based on the recent past, sampling daily consumption patterns, differentiated by day-types. The method is heuristic and uses input and control by human expert knowledge.

Patent EP 0 733 986 A2, Sept. 25, 1996

This patent describes a method of optimizing an inventory, based on a number of different criteria, such as a selected inventory investment or a service level constraint. A number of initial parameters such as forecasts are predefined. A level of an inventory investment or an inventory level constraint is found by marginal analysis. Gradients or slopes of constraint functions are used to improve the fit of an ensemble of parameters for the items concerned, to predefined service levels or investment constraints. Step-wise improved (on average) values for the ensemble can be obtained. This method is a refinement method for an initially known ensemble of parameters where optimal individual results are not guaranteed.

### AIM OF THE INVENTION

Current methods of calculating the reorder point and maximum stock level MSL can be improved, in particular by improving the accuracy of the estimates of the variance of the consumption over a certain period of time. A mathematical method avoiding sampling by periods of time, deriving the solution by solving a mathematical expression, using the historical data directly, yields the information required. The invention indicates how this aim can be realized.

### SHORT DESCRIPTION OF THE INVENTION

In agreement with the aim given the present invention provides a system and method to calculate optimal inventory control parameters for the use in a computer based inventory management system, which comprises at least one processor, memory, input and output. The system consists of a computer program, which calculates the moment of reordering as well as the quantity to reorder. The calculation is characterized by the use of moments of the single demand probability functions P(Q) for each item in the inventory to calculate the reorder point ROP and reorder quantity or the maximum stock level MSL using the formulae

E(R)=A1×E(L)×E(Q)

And

Var(R)=A2×E(L)×Var(Q)+A3×E(L)×E(Q)²+A4²×E(Q)²×Var(L)

Where

Aj parameter depending on the distribution function of Tj

Tj Time elapsed between the demands j-1 and j.

L The lead time, reorder period or production time

R Consumption in units over L

Q(i) Quantity in the single demand i during lead time

E(R) Expected consumption of item over L

E(L) Expected value of L

E(Q) Expected value for Q for any request i

Var(R) Variance of R

Var(Q) Variance of Q

Var(L) Variance of L

An alternative embodiment of the system comprises using the following formulae

$$P ( R ) = {\sum }_{j = 0}^{n} w j \times P j ( R )$$

Where

P(R) the probability distribution of R

P(Q) the probability distribution of Q for any request i

Pj(R) the jth selfconvolution of P(Q) (the joint probability for the total quantity of j requests)

wj the statistical weight of the corresponding joint probability distribution for 1 . . . n simultaneous demands in lead time L.

The reorder quantity is calculated from:

$$SL ( ROP ) = {\int }_{0}^{ROP} P ( R ) ⅆ R$$

In yet another alternative embodiment the following formula is applied

$$SL ( ROP ) = {\sum }_{j = 1}^{n} w j \times F j ( ROP )$$

Where

SL(ROP) Service level as function of the ROP

Fj(ROP) The cumulative distribution function of Rj

In still another alternative embodiment a completely general formula is applied:

$$L ( R ) = {\sum }_{j = 1}^{n} w j \times {[ L ( Q ) ]}^{j}$$

Where

L(Q) the Fourier transform of P(Q)

L(R) the Fourier transform of P(R)

P(R) is found by back-transforming the result just once.

P(R)=Fourier transform of (L(R))

From this expression ROP, given a desired service level SLcon, can be obtained directly.

### BRIEF DESCRIPTION OF THE DRAWINGS

FIG. 1 depicts the Q-system. If the stock reaches the reorder point ROP, an order is created. The reorder point ROP is calculated in such a way as to enable serving demands for items during the lead time L, with a certain pre-defined desired service level SLcon.

FIG. 2 depicts the fixed order cycle method, or the P-system, where on periodic time-intervals Tp an order is created. At periodic intervals, the quantity in stock is reviewed, and an order is created to re-supply the stock. The maximum stock level MSL enables demands to be served between inspections to a certain predefined service level SLcon. The lead time L is taken into account as well.

FIG. 3 depicts the relation between the stock, the lead time and variability of the lead time, and demand and variability in demand. The in reality step-wise decrease of the inventory stock is depicted as straight lines, the slope representing the total quantity demanded in the lead time.

FIG. 4 depicts a probability distribution which can be used to determine the reorder point.

FIG. 5 depicts two ways of representing the historical consumption over time of an item: First, each demand for an item is represented by a bar, the length of which is proportional to the quantity requested. Alternatively, the historical consumption is represented by sampling the total quantity demanded over a specific period of time.

FIG. 6 depicts two different demand patterns A and B, each are represented in two ways according to FIG. 5, as single demanded quantities representations A1 and B1, and as the demanded quantities sampled over periods, A2 and B2.

FIG. 7 depicts the same demand pattern A, in two ways A2 and A3: As sampled by periods using the same sampling period intervals, the sampling period intervals of A3 have been shifted with respect to A2.

FIG. 8 depicts a number of graphs clarifying the detailed description of the invention.

FIG. 9 depicts a diagram illustrating an aspect in the detailed description of the invention.

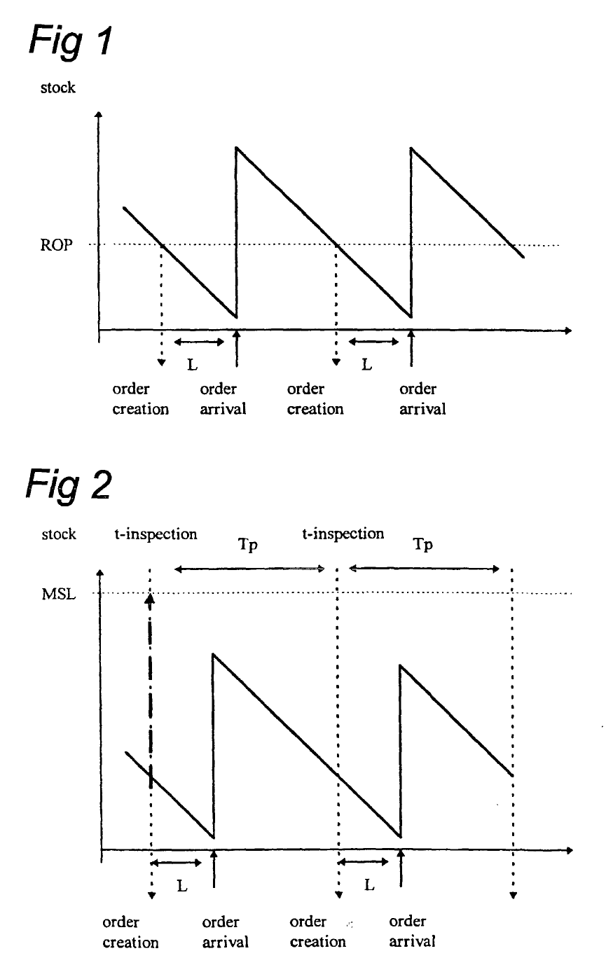

### DETAILED DESCRIPTION OF THE INVENTION

Using the values of the parameters calculated by the control system according to the invention, allows the inventory management system to optimize the service levels while minimizing the stock inventory and avoiding excess stock. The logistical parameters calculated by the system are:

For the Q-system (R. H. Ballou, Business Logistics Management, Prentice Hall Inc., 1992) the reorder point and the reorder quantity.

For the P-system (R. H. Ballou) or fixed order cycle method, the order to level or maximum stock level MSL and the periodic review period Tp.

For both Q-system and P-system the break quantity or exceptional demanded quantity threshold and lead times are calculated as well.

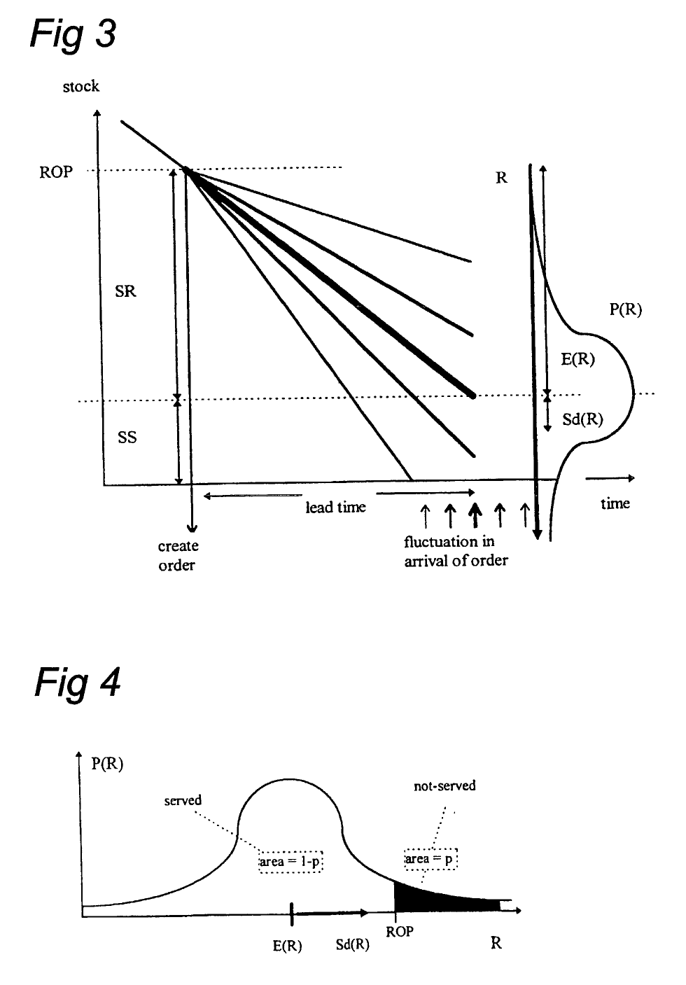

Currently, the reorder point is calculated as expected demand E(R), the so-called stock reserve SR, to which a quantity is added, the so-called safety stock SS, to cover larger than expected demand, caused by the variability in demand and lead times. See FIG. 3.

The reorder point ROP for Q-systems and order to level MSL for P-systems are calculated in exactly the same manner, the only difference being that ROP depends on the lead time L, whereas MSL depends on Tp+L. Therefore the equations below are given for ROP only. Similar calculations are equally applicable if the items are not re-supplied by ordering from a supplier, but are produced in batch-wise production with a limited production time and production setup time.

Current methods of determining reorder points generally use the following mechanism to estimate ROP: The probability distribution of P(R) is assumed to be a normal distribution (FIG. 4). If demand R>ROP, the demand will not be served. This constitutes the area or fraction p. The estimate of ROP is given by

ROP=E(R)+Z×Sd(R)

Where Z is given by Z=G−1(1−p) resulting in a service level s=(1−p)×100% (G is the standard normal distribution function).

Sd(R) is estimated by several methods, the one most commonly used is based on the mean weighted average absolute difference of the consumption and forecast over a number of historical periods:

$$MAD = {\sum }_{i = 1}^{n} wi \times \vert Forecast ( period i ) - Real demand ( period i ) \vert$$

Where the weights wi correspond generally to exponential smoothing, the factor 1.25 is used to convert the mean-absolute-deviation-value into the theoretical desired square-root-mean-squared-deviation

Sd(R)=1.25×MAD

The value of MAD should be corrected for the difference between L and the forecast time on which MAD is based.

A second method is based on an estimation of Sd(R) by direct estimation of the variance of the demand sampled in periodic intervals, to which an additional term is added, allowing for the variance of the lead time.

Var(R)=E(L)×Var(D)+[E(D)]²×Var(L)

Both of these methods are based on sampling the total quantity demanded D by periodic intervals only, rather than using the statistics based on individual demands. In this context terms such as “variability in demand” and “variance of demands” are not uncommon, however, this does not imply the use of individual demand statistics.

Note that sampling of demands in intervals actually leads to loss of information:

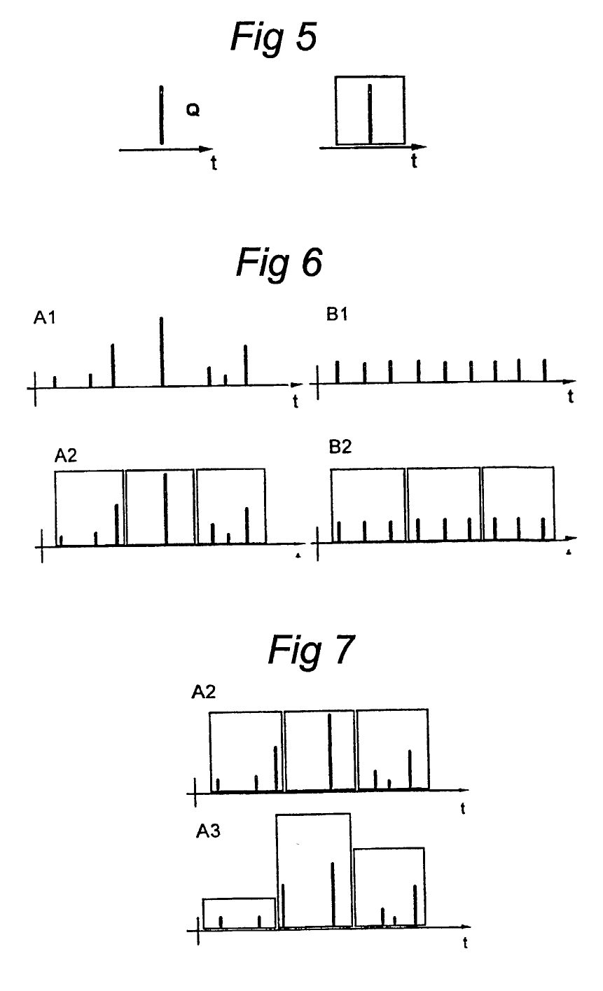

In FIG. 5, a bar represents a demand for a quantity q, the length of the bar is proportional to the quantity. A box represents the total demand D within a given period.

Two different patterns of demand are represented in FIG. 6 in pattern A1 and B1 respectively, together with the presentation of the same demand patterns sampled in periodic intervals in A2 and B2.

Clearly, sampling in a periodic way leads to the false conclusion that the non-identical patterns shown are in fact identical.

Moreover, as is depicted in FIG. 7, small changes in—or shifts of the period of sampling of the same pattern may lead to radically different estimates for the variance of the distribution as can be seen from A2 and A3, both periodic presentations of the same demand pattern A1. (Note that where the variance is highly dependent on the way the pattern is sampled, changing the sampling or shifting the presentation does not influence the mean or average expected quantity for a sampling period.)

Only the service level during lead time is important, the service level outside lead time is always at least equal to this. In the context of the invention, ROP is estimated from historic data while avoiding the problems mentioned above.

A Rigorous Mathematical Formalism

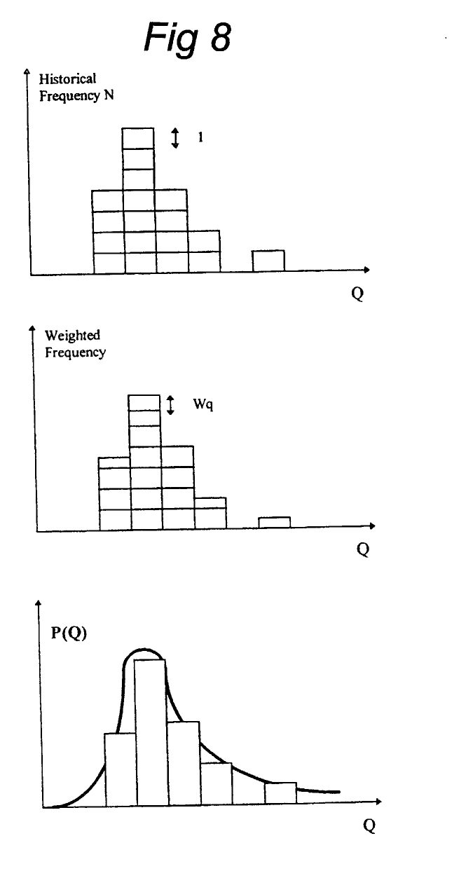

P(R) is derived from P(Q), where P(Q) is the empirical probability distribution, based on historical frequency data (FIG. 8.) which may be time-weighted using an empirical weighting scheme wq, down weighting inaccurate data and data obtained from a long time in the past.

If the weighted frequency distribution is used, the sum of the corresponding weights is taken for all demanded quantities pertaining to a certain interval, instead of the number of times a demanded quantity pertains to the same interval.

The historical frequency distribution is obtained by sampling Qi on a number of intervals q1, q2 . . . qm and counting the frequency of occurrence for each interval.

F(qm)=frequency Qi in interval qm=sum of 1 (Qi in interval qm)

The weighted frequency distribution is obtained by adding the to Qi corresponding weight wq instead of adding 1, when summing the number of occurrences for each interval.

Fw(qm)=sum of wq (Qi in interval qm)

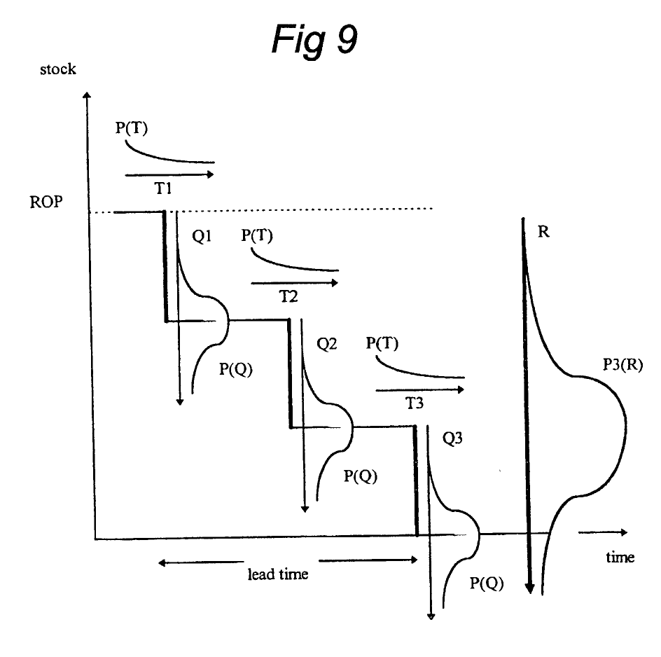

Given a number of demands, for instance 3 (FIG. 9.), the joint probability distribution P3(R) for the total consumption R of 3 demands, can be constructed from the single demand probability distribution P(Q).

The demand in the lead time, R, may arise from different numbers of demands j, each with a certain probability of occurring wj, and a probability distribution Pj(R) for the total quantity of the j demands.

Therefore P(R) is derived as a series,

$$P ( R ) = {\sum }_{j = 0}^{n} w j \times P j ( R ) \qquad ( formula 1 )$$

Where Pj(R) is the jth selfconvolution of P(Q) and wj is the statistical weight of the corresponding joint probability function for 1 . . . n simultaneous demands in the lead time L.

In practice values of n>100 need not be considered, as then the alternative approach given below is valid.

Under the assumption of the distribution of Ti being known—e.g. an exponential or truncated normal or Weibull, etc.—the coefficients wj can be calculated directly. This calculation of the coefficients can be modified to include the function P(L).

In the case of the distribution of Ti being exponential, for wj a Poisson distribution is the result, with a mean demand number density A equal to the expected number of demands during L divided by L. Calculation of P(R) is then straightforward if the functions Pj are known.

The functions Pj are not easily obtained directly, however estimates of sufficient accuracy of these convolutions are obtained by Fourier transformation of P(Q) and back-transforming the jth power of the transform obtained. However, P(R) may be obtained directly by first summing over j the jth powers of the transform of P(Q),

$$L ( R ) = {\sum }_{j = 1}^{n} w j \times {[ L ( Q ) ]}^{j} \qquad ( formula 2 )$$

using the weights wj, and back-transforming the result just once.

P(R)=Fourier transform (L(R)) (formula 3)

From this expression, ROP, given a desired service level SLcon, can be calculated easily. The reorder quantity is now calculated in a conventional manner.

$$SL ( ROP ) = {\int }_{0}^{ROP} P ( R ) ⅆ R \qquad ( formula 4 )$$

In order to improve the accuracy and avoid series termination effects in Fourier space, the Fourier-transform L(Q) can be multiplied with the, in the reciprocal space defined, weighting factor wL.

$$L ( R ) = {\sum }_{j = 1}^{n} w j \times {[ w L \times L ( Q ) ]}^{j} \qquad ( formula 2 B )$$

Alternatively, for certain probability distributions of P(Q), such as a normal or a gamma distribution, Pj(R) can be found analytically for all values of j. The ROP can be calculated using formula 4 directly or from the cumulative distribution functions Fj of Pj(R) in formula 5.

$$SL ( ROP ) = {\sum }_{j = 1}^{n} w j \times F j ( ROP ) \qquad ( formula 5 )$$

If the number of demands during lead time is sufficiently large, P(R) can be considered to be a normal distribution. In this case P(R) is fully defined by its mean value and variance. The mean may be obtained from

E(R)=A×E(L)×E(Q) (formula 6)

And the variance may be obtained from

Var(R)=A×E(L)×Var(Q)+A×E(L)×E(Q)²+A²×E(Q)²×Var(L) (formula 7)

The advantage is obvious in terms of speed and efficiency. However, it must be stressed that this approach is only valid if de number of demands is high.

Note that formula 7 comprises the (first and second moment, mean and variance) moments of the single demanded quantity probability distribution. The E(Q), Var(Q) may be time-weighted using an empirical weighting scheme wq, down weighting inaccurate data and data obtained from sampling a long time in the past.

E(Q)=Σwq×Qj/Σwq

And

Var(Q)=Σwq×(Qj−E(Q))²/Σwq

If in the Q-system the quantity in stock drops below the reorder point ROP by serving a demand, the calculation does not start at the reorder point ROP but at a point well below the reorder point. In order to compensate for this effect a correction term may be applied to the above mentioned formulae.

Variables used in the description, for each item in the inventory:

MAD Mean average absolute deviation between forecasted and actual consumption over a number of historical periods

D Demand rate, total quantity demanded by period

Var(D) Variance of D

L The lead time, re-order period or production time

P(L) Probability distribution function of L

E(L) Expected value of L

Var(L) Variance of L

R Consumption in units over L

P(R) Probability distribution function of R

E(R) Expected consumption of item over L

Var(R) Variance of R

Sd(R) Standard deviation of R

Tj Time elapsed between the (j-1)-th and the j-th demand

P(T) Probability distribution function of Tj

Rj Consumption in units of j demands over L

Pj(R) Probability distribution function of Rj

wj the statistical weight of the corresponding joint probability function Pj(R) for 1 . . . j simultaneous demands in lead time L.

Fj(ROP) The cumulative distribution function of Rj

Q(i) Quantity in the i-th single demand during lead time

wq Empirical weighting scheme, down weighting inaccurate data

P(Q) Probability distribution function of Q for any i

E(Q) Expected value for Q for any i

Var(Q) Variance of Q

A Mean demand number density

L(Q) Fourier transform of P(Q)

L(R) Fourier transform of P(R)

wL Weighting factor in reciprocal space

ROP Reorder point

SL Service level

SL(ROP) Service level as function of the ROP

SLcon Desired service level

Tp The time between periodic reviews

MSL Order-to-level or maximum-stock-level

What is claimed:

1. A method of maintaining an inventory of an item for which a statistical history of individual demands for the item is known, the method comprising the steps of:
first determining, independently of time and based on the history of individual demands, a probability distribution P(Q) of a quantity of an individual demand that is independent of time, including a mean value E(Q) and a variance Var(Q);
second determining a variance of consumption Var(R) based on the determined P(Q);
third determining at least one of when to place an order and a size of an order for the item, based on the determined variance of consumption Var(R); and
placing an order for the item at the determined time or of the determined size, based on the results of the third determining step.

2. The method of claim 1, further comprising the step of determining, from the history of individual demands, a distribution function of time between the individual demands, and wherein the determination of the variance of consumption Var(R) is further based on the determined distribution function of time between the individual demands.

3. The method of claim 2, further comprising the step of determining a probability distribution of a first time period L prior to receipt of the order, the first time period being one of a lead time, a production time of the item, a fixed reorder period, and wherein the determination of the variance of consumption Var(R) is further based on the determined probability distribution of the first time period L.

4. The method of claim 3, wherein the variance of consumption Var(R) is determined from the following,
Var(R)=A2×E(L)×Var(Q)+A3×E(L)×E(Q)²+A4×E(Q)²×Var(L)
where A2, A3, A4 are parameters depending on the distribution function of the time between demands, E(L) and Var(L) are the mean value and variance of the first time period L, and E(Q) and Var(Q) are the mean value and variance of P(Q).

5. The method of claim 4, wherein A2=A3=A4
where A2 is the number of single demands per time unit.

6. The method of claim 3, wherein the variance of consumption is derived from P(R), a probability function of consumption that is determined from the following
$$P ( R ) = {\sum }_{j = 0}^{n} ( w j \times P j ( R ) )$$
where Pⱼ(R) is the jth selfconvolution of P(Q), and wⱼ is a statistical weight of a corresponding joint probability function for 1 . . . n simultaneous demands during the first period.

7. The method of claim 3, wherein the variance of consumption is derived from P(R), a probability function of consumption that is determined from the following
$$L ( R ) = {\sum }_{j = 1}^{n} ( {w}_{j} \times ( {L ( Q )}^{j} )$$
where L(R) is the Fourier transform of P(R), L(Q) is the Fourier transform of P(Q), and wⱼ is a statistical weight of a corresponding joint probability function for 1 . . . n simultaneous demands during the first period.

8. A method of maintaining an inventory of an item for which a statistical history of individual demands for the item is known, the method comprising the steps of:
first determining, from the history of individual demands and without sampling over time intervals, a probability distribution P(Q) of a quantity of an individual demand;
second determining, from the history of individual demands, a distribution function of time between the individual demands;
third determining a probability distribution of a first time period prior to receipt of an order for the item, the first time period being one of a lead time, a production time of the item, and a reorder period;
fourth determining a variance of consumption based on the determined P(Q), the determined distribution of time between the individual demands, and the determined probability distribution of the first time period;
fifth determining at least one of when to place an order and a size of an order for the item, based on the determined variance of consumption; and
placing an order for the item at the determined time or of the determined size, based on the results of the fifth determining step.

9. The method of claim 8, wherein the variance of consumption is Var(R) and is determined from the following,
Var(R)=A2×E(L)×Var(Q)+A3×E(L)×E(Q)²+A4²×E(Q)²×Var(L)
where A2, A3, A4 are parameters depending on the distribution function of the time between demands, E(L) and Var(L) are the mean value and variance of the first time period, and E(Q) and Var(Q) are the mean value and variance of the P(Q).

10. The method of claim 9, wherein A2=A3=A4
where A2 is the number of single demands per time unit.

11. The method of claim 8, wherein the variance of consumption is derived from P(R), a probability function of consumption that is determined from the following
$$P ( R ) = {\sum }_{j = 0}^{n} ( {w}_{j} \times {P}_{j} ( R ) )$$
where Pⱼ(R) is the jth selfconvolution of P(Q), and wⱼ is a statistical weight of a corresponding joint probability function for 1 . . . n simultaneous demands during the first period.

12. The method of claim 8, wherein the variance of consumption is derived from P(R), a probability function of consumption that is determined from the following
$$L ( R ) = {\sum }_{j = 1}^{n} ( {w}_{j} \times ( {L ( Q )}^{j} )$$
where L(R) is the Fourier transform of P(R), L(Q) is the Fourier transform of P(Q), and wⱼ is a statistical weight of a corresponding joint probability function for 1 . . . n simultaneous demands during the first period.

13. A method of maintaining an inventory of an item for which a statistical history of individual demands for the item is known, the method comprising the steps of:
first determining, from the history of individual demands, a probability distribution P(Q) of a quantity of an individual demand;
second determining a variance of consumption from the following,
Var(R)=A2×E(L)×Var(Q)+A3×E(L)×E(Q)²+A4×E(Q)²×Var(L)
where A2, A3, A4 are parameters depending on a distribution function of a time between individual demands, E(L) and Var(L) are the mean value and variance of a first time period before receipt of an order, and E(Q) and Var(Q) are the mean value and variance of the P(Q);
third determining at least one of when to place an order and a size of an order for the item, based on the determined variance of consumption; and
placing an order for the item at the determined time or of the determined size, based on the results of the third determining step.

14. The method of claim 13, wherein A2=A3=A4
where A2 is the number of single demands per time unit.
